(19) United States
(12) Patent Application Publication
(10) Pub. No.: US 2013/0135303 A1
(43) Pub. Date: May 30, 2013

(54) System and Method for Visualizing a Virtual Environment Online

(71) Applicant: CAST Group of Companies Inc., Toronto (CA)

(72) Inventor: Gilray DENSHAM, Inglewood (CA)

(73) Assignee: CAST Group of Companies Inc., Toronto (CA)

(21) Appl. No.: 13/687,616

(22) Filed: Nov. 28, 2012

Related U.S. Application Data
(60) Provisional application No. 61/564,037, filed on Nov. 28, 2011.

(51) Int. Cl. G06T 17/00

(52) U.S. Cl. CPC G06T 17/00
USPC 345/420

(57) ABSTRACT

Systems and methods are provided to allow a user to visualize a 3D model of a venue and to customize the 3D model of the venue according to their own needs. A data abstraction of the 3D venue model is created and sent to the venue operator. This data abstraction can be used to reconstruct the 3D venue model in a 3D virtual environment software. The customized 3D venue model is generated by: displaying on a web browser a 3D venue model; displaying one or more virtual objects available in an objects library; customizing the 3D venue model by receiving an input to place a selected virtual object in the 3D venue model; receiving an input to save the customized 3D venue model; and generating a text file comprising a name of the 3D venue model and data describing one or more characteristics of the selected virtual object.

### TECHNICAL FIELD

The following relates generally to visualizing virtual environments.

### DESCRIPTION OF THE RELATED ART

More people are using the internet, or web, to determine if a venue is appropriate. For example, a person may research a hotel or banquet hall to determine if the rooms are appropriate to their needs. Typically, a venue operator, such as hotel management or banquet hall management, will provide, through their website, photographs of the venue and may include additional information, such as the maximum number of people the venue can accommodate. If the person is interested in the venue, the person may contact the venue operator for more information and may arrange an in-person visit to the venue.

### BRIEF DESCRIPTION OF THE DRAWINGS

Embodiments will now be described by way of example only with reference to the appended drawings wherein:

FIG. 1 is a system diagram illustrating an example configuration of a venue server, a virtual environment server, and a user computing device.

FIG. 2 is a system diagram showing example components of a web application.

FIG. 3 is a flow diagram illustrating example computer executable instructions for creating a customized 3D venue model.

FIG. 4 is a flow diagram illustrating example computer executable instructions for creating a customized 3D venue model including the perspective of the user's computing device.

FIG. 5 is a flow diagram illustrating example computer executable instructions for an emergency exit safety rule.

FIG. 6 is a flow diagram illustrating example computer executable instructions for a safety rule regarding the maximum number of chairs.

FIG. 7 is a flow diagram illustrating example computer executable instructions for determining if objects in the 3D venue model are colliding.

FIG. 8 is a flow diagram illustrating example computer executable instructions for saving a customized 3D venue model.

FIG. 9 is a flow diagram illustrating example computer executable instructions for receiving data related to the customized 3D venue model and reconstructing the 3D venue model using the received data.

FIG. 10 is an example graphical user interface (GUI) of the web application illustrating a top-down view of an example customized 3D venue model.

FIG. 11 is the example GUI of the web application illustrating an isometric perspective view of the example customized 3D venue model shown in FIG. 10.

FIG. 12 is the example GUI of FIG. 11, further including an option menu to modify attributes of one of the objects in the customized 3D venue model.

FIG. 13 is the example GUI of FIG. 11, further including an option menu to select a table from the objects library.

FIG. 14 is the example GUI of the web application illustrating a first-person perspective of the example customized 3D venue model shown in FIG. 10.

FIG. 15 is the example GUI of the web application illustrating another first-person perspective of the example customized 3D venue model shown in FIG. 10.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It is recognized that a user's experience while researching venues over the internet using a web browser is typically limited. Websites typically provide photos of a venue and, in some cases, some additional written information (e.g. maximum capacity of people). A user may find it difficult to visualize using the venue for their needs based on such limited information.

It can be appreciated that a venue, as described herein, generally refers to any defined space. Non-limiting example of venues include: hotel rooms, conference rooms, stadiums, banquet halls, concert halls, an auditorium, a gymnasium, outdoor parks, dining rooms, a living room in a house, a bedroom, a kitchen, a bathroom, a boardroom, a classroom, a warehouse, a dance studio, etc.

Systems and methods, as described herein, are provided to allow a user to visualize a three-dimensional (3D) model of a venue and to customize the 3D model of the venue according to their own needs. This can be done through a web application. A data abstraction of the 3D venue model is created and sent to the venue operator. The venue operator can use the data abstraction of the 3D venue model to reconstruct the 3D venue model in a 3D virtual environment software. An example of such a 3D virtual environment software is available under the trade-mark Vivien provided by CAST Group of Companies Inc.

The user can use such a tool to design a venue to their liking. The venue operator can use the tool to obtain information about the user and to provide services and materials catered to the user based on the user's customized 3D venue model.

In another scenario, a user can use such a tool to design a venue to their liking, such as when selecting furniture for a room in their house. After developing a 3D venue model that shows the positions of various furniture items, a user can proceed to purchase the selected furniture items (for example, through the web application).

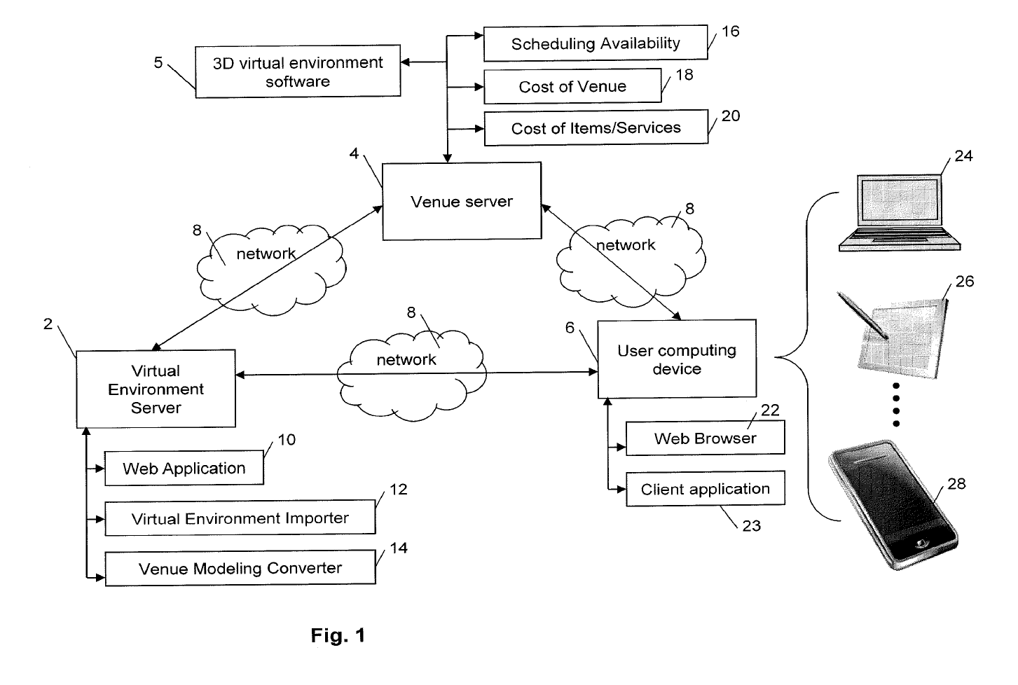

Turning to FIG. 1, a virtual environment server 2, a venue server 4 and a user computing device 6 are shown in communication with each other over a network 8. The network 8 can be a wireless network, an internet network, a phone carrier network, etc. The user computing device 6 may connect to a website of the venue server 4, for example, using the computing device's web browser 22. The venue server 4 may then direct the web browser 22 to a website hosted by the virtual environment server 2. In another example embodiment, the functions and data of the virtual environment server 2 and the venue server 4 reside on a single server which can communicate with the user's computing device 6. Non-limiting examples of the computing device 6 include a desktop computer, a laptop 24, a tablet 26, a mobile phone 28, a personal digital assistant, a net-book, a mobile device, etc.

The servers and computing devices each include a processor device, a memory device, and a communication device for interacting with the network 8.

The virtual environment server 2 includes a web application 10 which can be displayed on the computing device 6, a virtual environment importer 12, and a venue modelling converter 14. The web application 10 provides a graphical user interface (GUI) over the internet that allows a user to visualize the 3D venue model and to customize the same. The virtual environment importer 12 is a module that imports a data abstraction of the 3D venue model and aids in the reconstruction of the complete 3D venue model. The venue modeling converter 14 converts a file format of the 3D venue model, as created in the 3D virtual environment software 5, to another file format suitable to be processed and displayed by the web application 10.

The venue server 4 includes a module for tracking scheduling availability 16 of each venue, a module for setting the cost of the venue 18, and a module for setting the cost of items or services, or both. Such information can be stored in a database on the venue server 4, and can be used to correlate with the customized 3D venue models generated by users.

In an example embodiment, the web application 10 interacts only with the 3D virtual environment software 5, which resides on the venue server 4. The web application 10 sends the data abstraction of the 3D venue model to the 3D virtual environment software 5. The 3D virtual environment software 5 communicates with the modules 16, 18 and 20 to provide cost estimates of the venue and the objects and services associated with the event, as well as the scheduling availability.

In an example embodiment, in addition to, or in alternative to a user using the web browser 22 on the computing device 6, a client application 23, sometimes called a mobile application, may be installed on the computing device 6. The client application 23 can display the information provided by the venue server 4 and the virtual environment server 2, as well as receive inputs from the user. Although the example embodiments provided below refer to the web browser 22, it can be appreciated that a client application 23 can also be used.

In another example embodiment, the functions of the venue server 4 and the virtual environment server 2 may be performed by a single server.

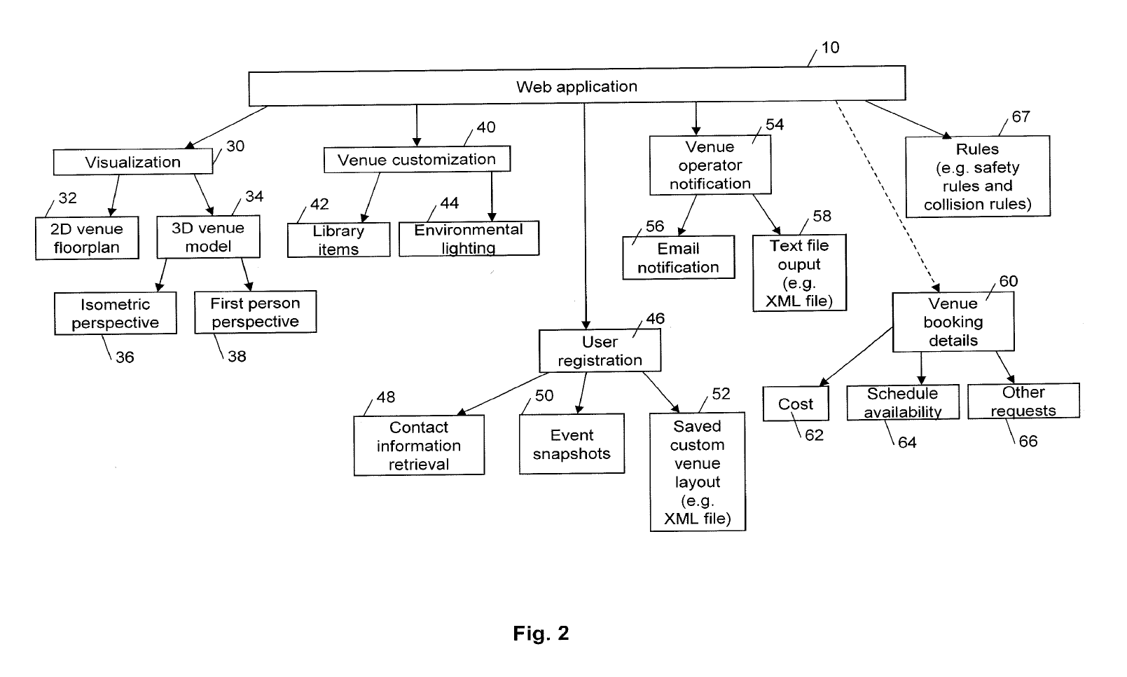

Turning to FIG. 2, example components of the web application 10 are provided. The visualization module 30 includes a 2D floor plan of a venue 32 and a 3D venue model 34. The 3D venue model 34 can be viewed from an isometric perspective 36 and from a first person perspective 38.

The venue customization module 40 includes a library or database of items 42. These items can be identified by name, and have associated therewith certain properties or characteristics that may be modified by a user. Such characteristics include, for example, color, height, position, material, rotation, pattern, etc. Each item typically includes the data to construct a 3D model of the item, which can be visualized or displayed in a 3D virtual environment. Non-limiting examples of items include chairs, tables, stages, lights, people, beds, bookshelves, plants, etc. The venue customization module 40 also includes an environmental lighting module 44 which stores various lighting settings associated with the venue. Example lighting settings include daylight or night lighting.

The user registration module 46 has a module to retrieve contact information from the user 48, a module to generate and save snapshots of the 3D venue model 50, and a module to save the custom venue layout 52. A data abstraction of the customized 3D venue model may also be saved, for example in a text file. The text file may, for example, be an extensible markup language (XML) file.

It can be appreciated that the data abstraction, described herein, refers to data describing customizations to the 3D venue model. The data is much smaller in size compared to the graphical data used to display the customized 3D venue model. This allows the data to be easily transferred, for example by email. It can be appreciated that a 3D model of a venue would have a large data size, and thus may be more difficult to send over the network 8. The data contains information that can be used to reconstruct and display the customized 3D venue model. In an example embodiment, the data used to describe the customizations is text data. When a designer, venue operator, a customer wishing to book the venue, or other user obtains the data abstraction, the data abstraction can be used to generate a full 3D venue model and display the same.

The module 54 for notifying the venue operator is able to email a notification to the venue operator 56 and to output a data abstraction of the customized 3D venue module 58, such as a text file or more particularly an XML file.

The venue booking module 60 includes modules to manage and view information related to cost 62, scheduling availability of the venue 64, and other requests 66.

In an example embodiment, module 60 is not directly accessed by the web application 10. Rather, module 60 is part of, or accessible by, the 3D virtual environment software 5. In other words, the web application 10 accesses module 60 through the 3D virtual software 5.

The web application 10 may also include a set of rules 67 related to safety and to collision. The rules can be applied to govern where objects, for example from the library 42, are placed in the venue. Some rules may be specific to a certain venue. Some rules may be generalized across all venues.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the virtual environment server 2, computing device 6 or venue server 4, or accessible or connectable thereto. Any application or module herein described may be implemented using computer readable/executable instructions or operations that may be stored or otherwise held by such computer readable media.

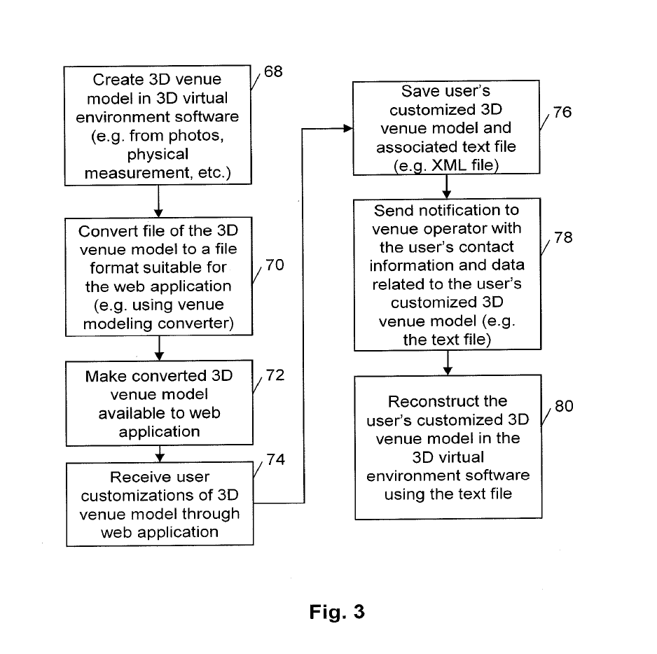

Referring to FIG. 3, example computer executable instructions are provided for creating and managing a customized 3D venue model. At block 68, a 3D venue model is created in a 3D virtual environment software. This can be done, for example, by using photographs of the venue, physical measurements of the venue, etc. The 3D venue model is a data file including graphical information, and it is converted to a file format suitable for the web application 10 (block 70). This operation can be performed, for example, by the venue modeling converter 14. The converted 3D venue model is made available to the web application 10 (block 72).

The web application 10 receives user-selected customizations of the 3D venue model (block 74). The user's customized 3D venue model and associated data abstraction file are saved, for example, to the virtual environment server 2 (block 76). At block 78, the virtual environment server 2 sends a notification to the venue operator (e.g. venue server 4) with the user's contact information and the data abstraction of the user's customized 3D venue model (e.g. a text file or XML file). At block 80, the virtual environment server 2, venue server 4, or some other computing device operating the 3D virtual environment software, reconstructs the user's customized 3D venue model using the data abstraction.

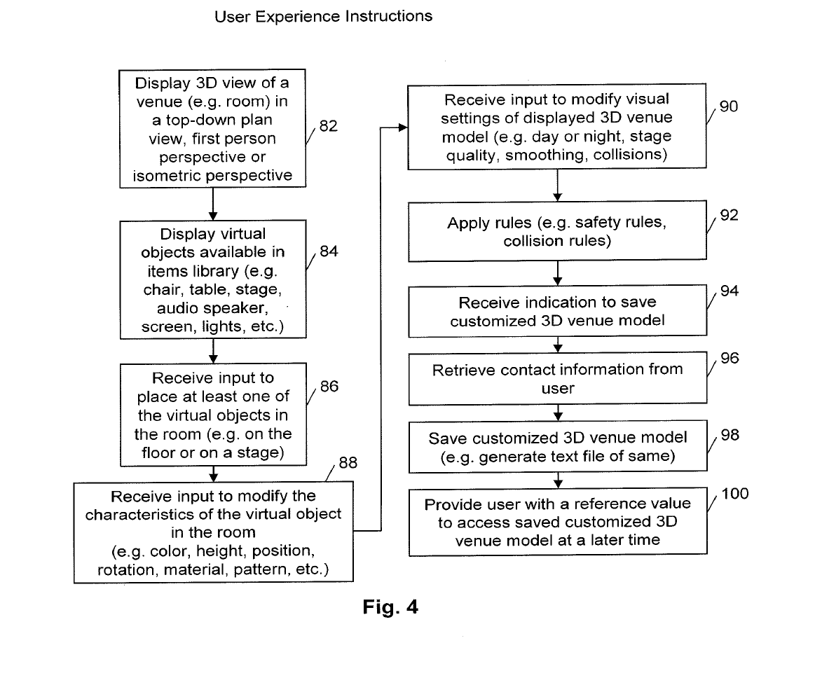

Turning to FIG. 4, example computer executable instructions are provided from the perspective of the user's computing device 6. The data displayed on the user's computing device 6, however, is provided by the venue server 4 or the virtual environment server 2, or both. Details are provided below. At block 82, a 3D view of a venue is displayed, for example, in a top-down view, a first-person perspective, or an isometric perspective. The 3D venue model is provided by the web application 10 and is displayed, for example, on a web browser 22. Typically, the venue is shown to be blank, without being populated by furniture items. The venue may be shown to look like the venue as realistically as possible (e.g. carpeting, curtains, pillars, wall paper, etc.). At block 84, virtual objects available in the library of items 42 are displayed. These, for example, can include, a chair, a table, a stage, an audio speaker, a screen, lights, etc. At block 86, the computing device 6 receives an input to place or position at least one of the virtual objects in the venue. In an example embodiment, the virtual object will, by default, be positioned on the floor or on top of the stage. In another example embodiment, the virtual object, will by default, have a Z-axis coordinate (e.g. the vertical position) of ‘0’. For example, the coordinate (0,0,0) marks the coordinates of the origin in the 3D venue model, typically located on the ground of the venue. At block 88, the computing device 6 receives an input to modify the characteristics of the virtual object in the venue. These characteristics can include color, height, position, rotation, material, pattern, etc. At block 90, an input is received to modify visual settings of the displayed 3D venue model. Settings include, for example, day or night lighting, stage quality, smoothing, collisions, etc. At block 92, it is determined if any rules are applicable. For example, rules may include safety rules and collision rules which dictate where objects can be positioned in the venue. The determination of which rules are applied may be determined by the web application 10, according to the rules module 67.

At block 94, the computing device 6 receives an input to save the customized 3D venue model. The computing device 6 displays a GUI to retrieve the contact the information from the user. In an example embodiment, the user must provide the contact information to the computing device (via the web application 10) in order to save the customized 3D venue model. This allows the venue operator to follow-up and contact the user, who is considered a potential customer of the venue operator. Examples of contact information include name, email address, phone number, address, etc. At block 98, the customized 3D venue model is saved. For example, the computing device 6 may indicate to the server 2 that the customized 3D venue model should be saved, and the server 2 generates a data abstraction of the same (e.g. a text file or XML file). At block 100, the computing device 6 provides the user or displays to the user a reference value which is used to access the saved customized 3D venue model at a later time.

The inputs received by the computing device 6 may be user inputs. For example, a user can provide inputs to the computing device 6 through a GUI to make customizations, place objects in the venue, take snapshots, input contact information, etc.

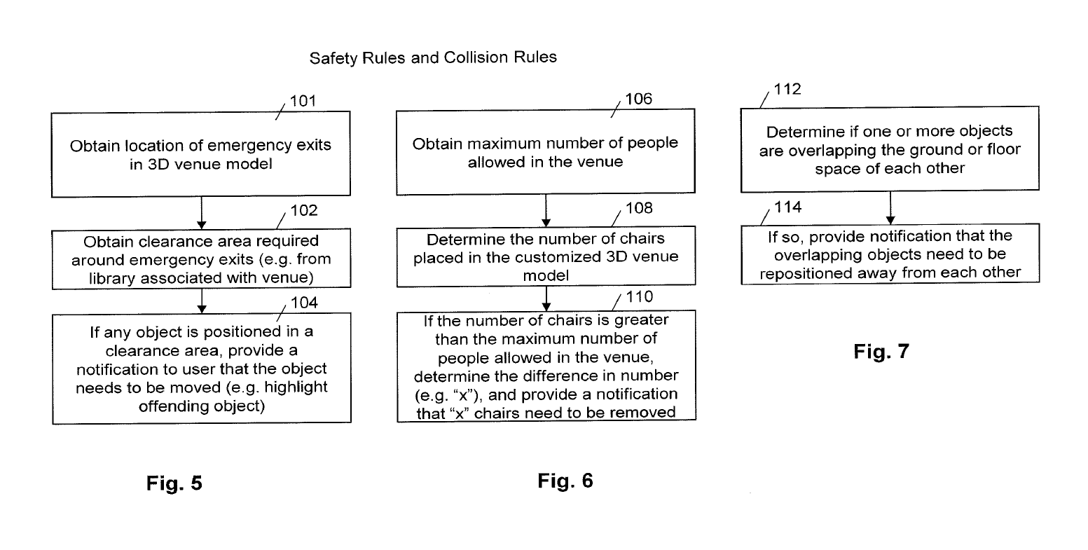

Turning to FIG. 5, example executable instructions for a safety rule are provided. The rules can be stored and applied by the rules module 67. At block 101, the location of each emergency exit in the 3D venue model is obtained. At block 102, the clearance area required around the emergency exit is obtained. This data can be stored in the library 42, for example. At block 104, it is determined if an object is positioned in a clearance area. If so, a notification is provided to the user that the offending object needs to move. The offending object may also be highlighted as part of the notification. In another example embodiment, the rule does not allow a user to place the object in such a clearance area in the first place.

The clearance rule of FIG. 5 may also be applied to establishing a clearance area around the walls. For example, for fire safety reasons, objects (e.g. chairs, seating) are to be positioned at a minimum predetermined distance away from the walls of the venue. In other words, if a user attempts to place an object close to a wall, but it is determined that it is positioned less than the minimum predetermined distance, the web application 10 will provide a warning to the user to move the object. Alternatively, the web application 10 will automatically compute a new position of the object and move the object away from the wall (e.g. or other virtual object in the 3D venue model) so that the object is positioned to at least the minimum predetermined distance.

Turning to FIG. 6, example executable instructions for another safety rule include obtaining the maximum number of people allowed in the venue (block 106). At blocks 108 and 110, it is determined if the number of chairs placed in the customized 3D venue model is greater than the maximum number people allowed. If so, the excess difference is computed and a notification is provided to the user, via the user's computing device 6, to remove at least the excess difference of chairs from the customized 3D venue model.

Turning to FIG. 7, at block 112, it is determined if one or more objects are overlapping to the ground space of each other, or are too close to each other. At block 114, if so, then a notification is provided via the computing device 6 that the overlapping objects need to be repositioned away from each other.

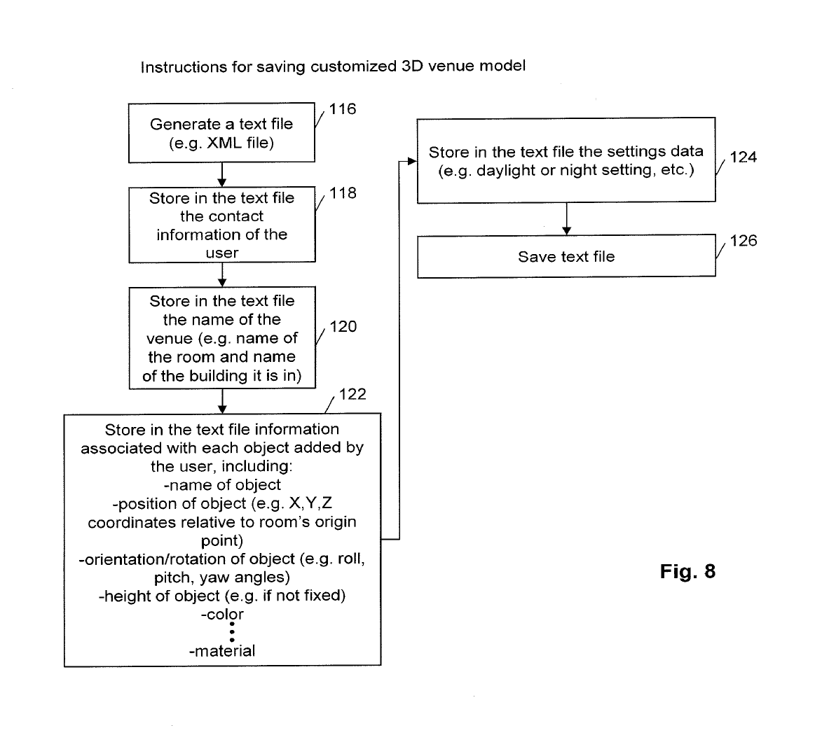

Turning to FIG. 8, example computer executable instructions are provided for saving a customized 3D venue model. At block 116, a text file, such as an XML file is created. At block 118, the contact information of the user is stored in the text file. At block 120, the name of the venue (e.g. name of the room and the building it is in) is stored in the text file. At block 122, the information associated with each object (e.g. from the library 42) added by the user to the customized 3D venue model is stored in the text file. The information includes the name of the object, the position of the objects (e.g. XYZ coordinates), the orientation or rotation of the object (e.g. roll, pitch, yaw angles), the height of the object from “0”, the color, etc. The settings data is also stored in the text filed (block 124). The text file is then saved (block 126). The data in the text file can be considered the metadata of the now customized 3D venue model. This text file or XML file may also be considered as the data abstraction of the customized 3D venue model.

A non-limiting example embodiment of an XML file is provided below:

TABLE 1

<?xml version=″1.0″ encoding=″UTF-8″ ?>
<vivonline version=″x.y.z″ file_id=”1.0”>

<venue name=″Pebble Beach″ id=″PBBLVVN″>

<workarea>

<obj id=″1″ type=″table″ class=″PPBL_TBL_1″>

<varient>

<color>

2A00FF

</color>

</varient>
<position>

<x>0</x>
<y>0</y>
<z>0</z>

</position>
<rotation>

<x>0</x>
<y>0</y>
<z>0</z>

</rotation>

</obj>
.
.
.

</workarea>

</venue>
<user id=”000A1”>

<name>

<first>

Jane

</first>
<last>

Doe

</last>

</name>
<email>

janed@gmail.com

</email>
<phone>

555-5555

</phone>

</user>

</vivonline>

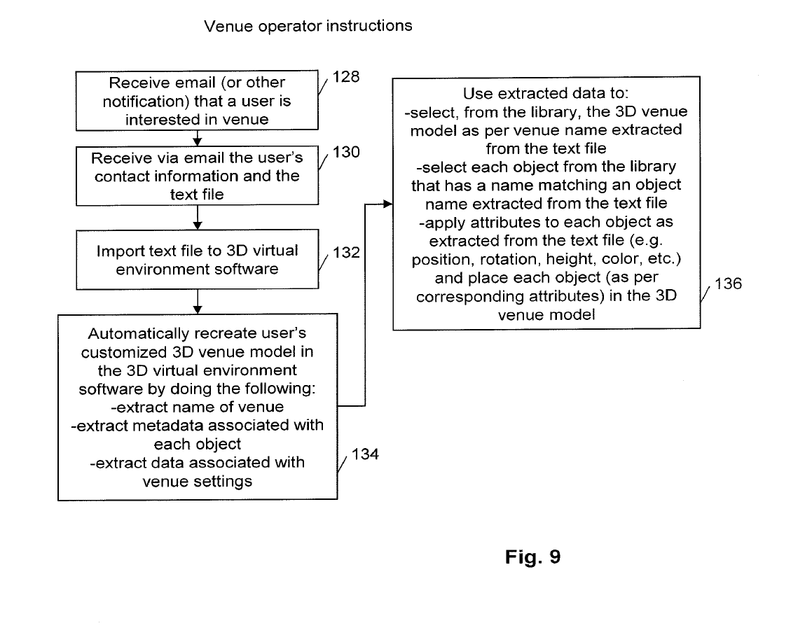

Turning to FIG. 9, example computer executable instructions from the venue operator's device is provided. At block 128, an email is received that a user is interested in a venue. At block 130, also received via the email is the user's contact information and the text file. At block 132, the text file is imported to the 3D virtual environment software. It can be appreciated that the text file contains text, and its data size is small compared to a 3D graphics file. At block 134, the importer (e.g. module 12) automatically recreates the user's customized 3D venue model in the 3D virtual environment software by doing the following: extracting the name of the venue; extracting the metadata (e.g. name or unique identifier of object, position, orientation, color, etc.) associated with each object; and extracting data associated with the venue settings.

At block 136, the 3D venue model is selected from a library based on a name or unique identifier that matches the extracted venue name from the text file. Similarly, 3D graphic objects are selected from a 3D graphics library that has a name or unique identifier matching the objects' names or unique identifiers extracted from the text file. The characteristics of each object (e.g. position, color, orientation, etc.) as extracted from the text file are applied to each of the corresponding the 3D graphic objects. The 3D graphic objects are placed in the 3D venue model accordingly, thereby forming the user's customized 3D venue model.

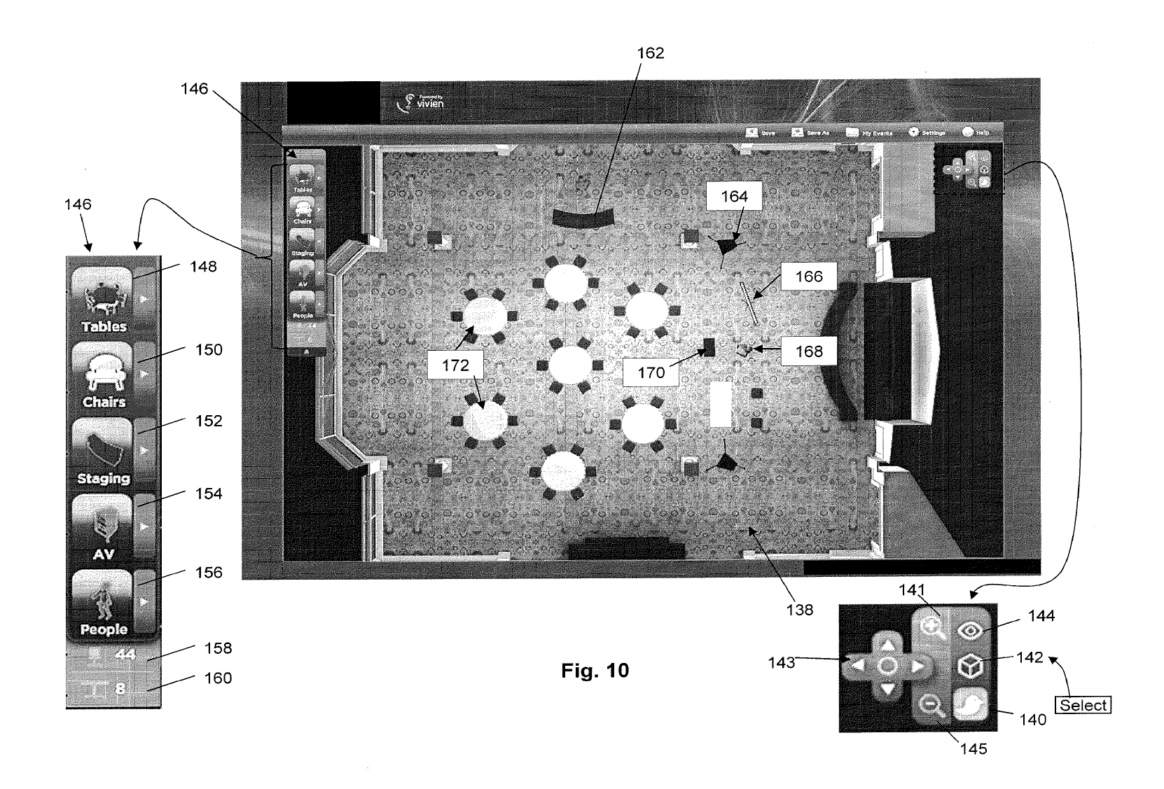

FIG. 10 through FIG. 15 are example GUIs of the web application 10 which may be displayed on the computing device 6.

Referring to FIG. 10, the top-down view of an example venue 138 is shown. Perspective controls 140, 142, 144 are shown. In FIG. 10, the top-down view control 140 is currently selected. For example, this is evidenced by the highlighted control 140. Selecting the control 142 will show the venue 138 from an isometric perspective, and selecting the control 144 will show the venue 138 from a first-person perspective. There are also controls 143 to change the point of view, by moving up, down, left and right. There is also a zoom-in control 141 and a zoom-out control 145.

A control panel 146 also allows items from the library 42 to be selected and added to the venue 138. The items can be selected from the panel 146 and dragged to a position in-the venue 138. The items are categorized by tables 148, chairs 150, staging 152, audio visual 154, and people 156. The inventory shows that there are currently forty-four chairs (158) being used in the venue 138, as well as eight tables (160). The venue 138 may be originally blank, and items were added by a user. For example, a bar table 162, an audio speaker 164, a slideshow screen 166, a person 168, a podium 170, and tables 172 were added.

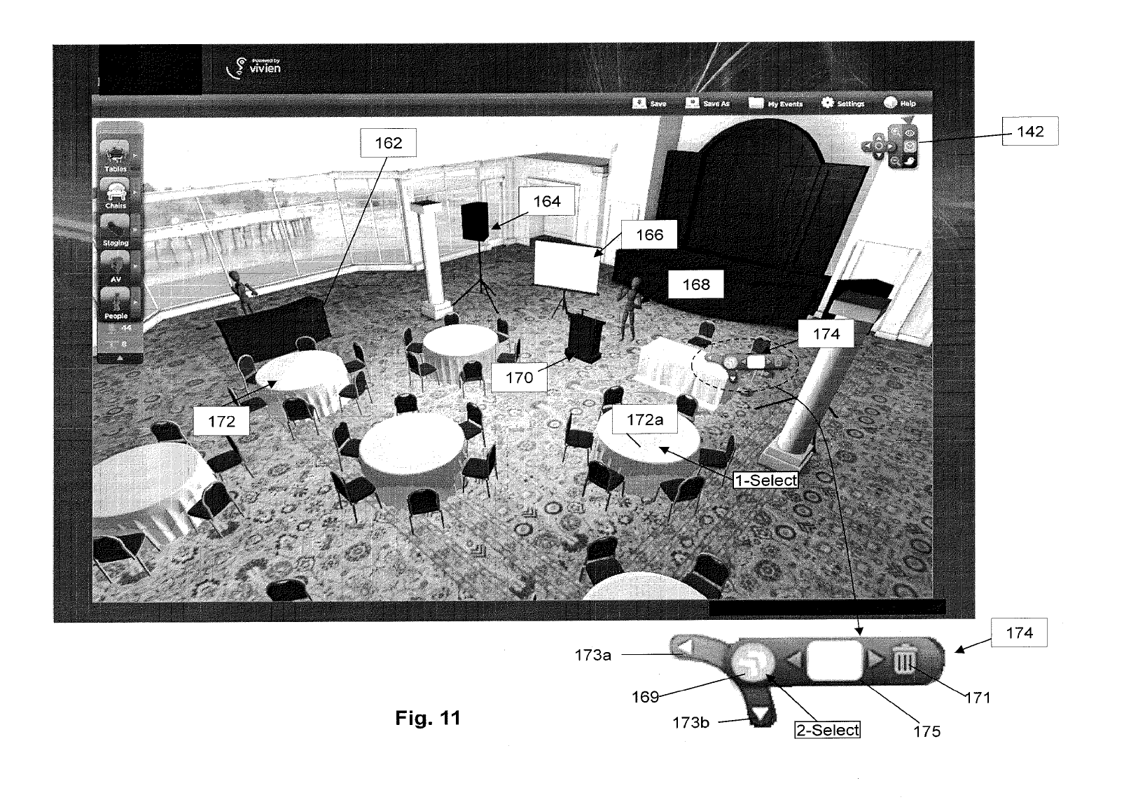

Upon selecting the control 142 in FIG. 10, an isometric perspective is shown in FIG. 11.

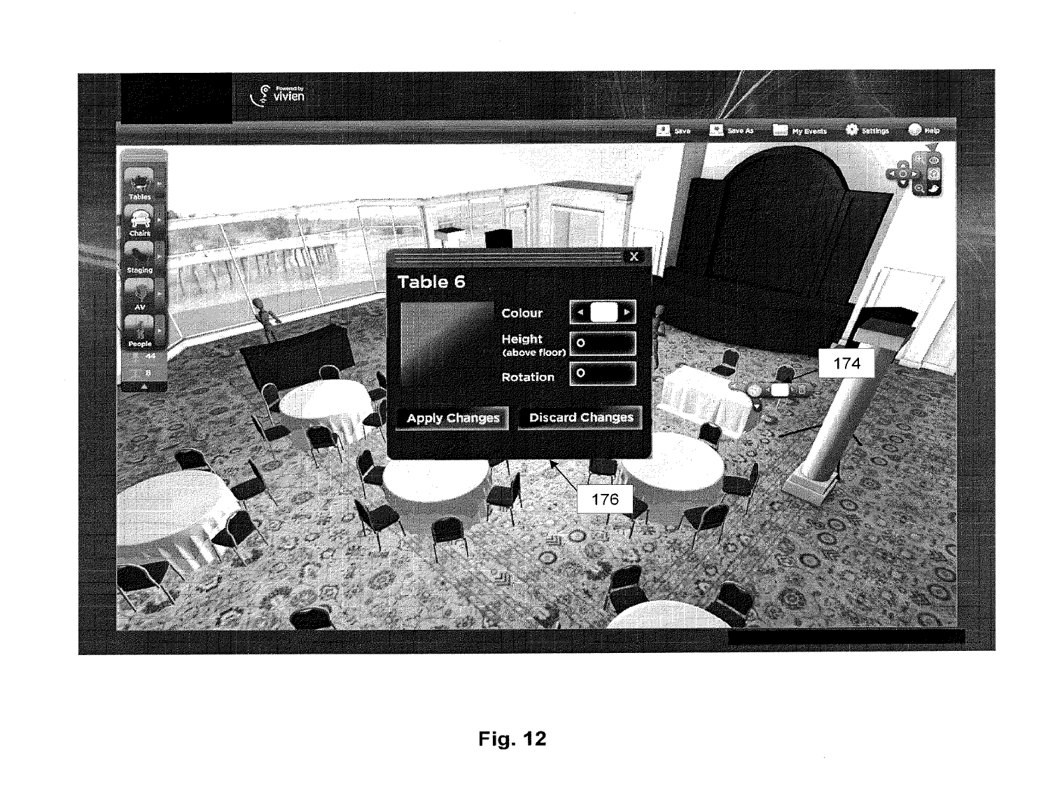

FIG. 11 shows that the control 142 is highlighted, indicating the current isometric perspective of the venue 138. Upon selecting a table 172a (“1-Select”), an options panel 174 appears. The option panel 174 displays controls that allow the user to modify the characteristics (e.g. color, height of ground, etc.) of the selected table 172a. For example, a color selection control 175 allows a user to select the color of the table or table cloth. Control 171 allows the user to delete the current object (e.g. the selected table 172a) from the venue 138. Controls 173a and 173b, when selected, change the point of view being displayed, but relative to the current object (e.g. the selected table 172a). In this way, the user can see the selected table 172 in the context of the venue from different angles and positions. In another example embodiment, controls 173a and 173b are used to rotate the selected object (e.g. the selected table 172a). Selecting an expansion button 169 on the panel 174 (“2-Select”) causes an expanded options panel to appear. The expanded options panel is shown in FIG. 12.

The options panel 174 may be small and is positioned so that the selected object is displayed at the same time. Therefore, any changes being made to the selected object using the options panel 174 can be visualized.

Referring to FIG. 12, the expanded options panel 176 includes options to modify the color of the table, the height of the table above the floor, the rotation angle, etc. The changes can be applied or discarded.

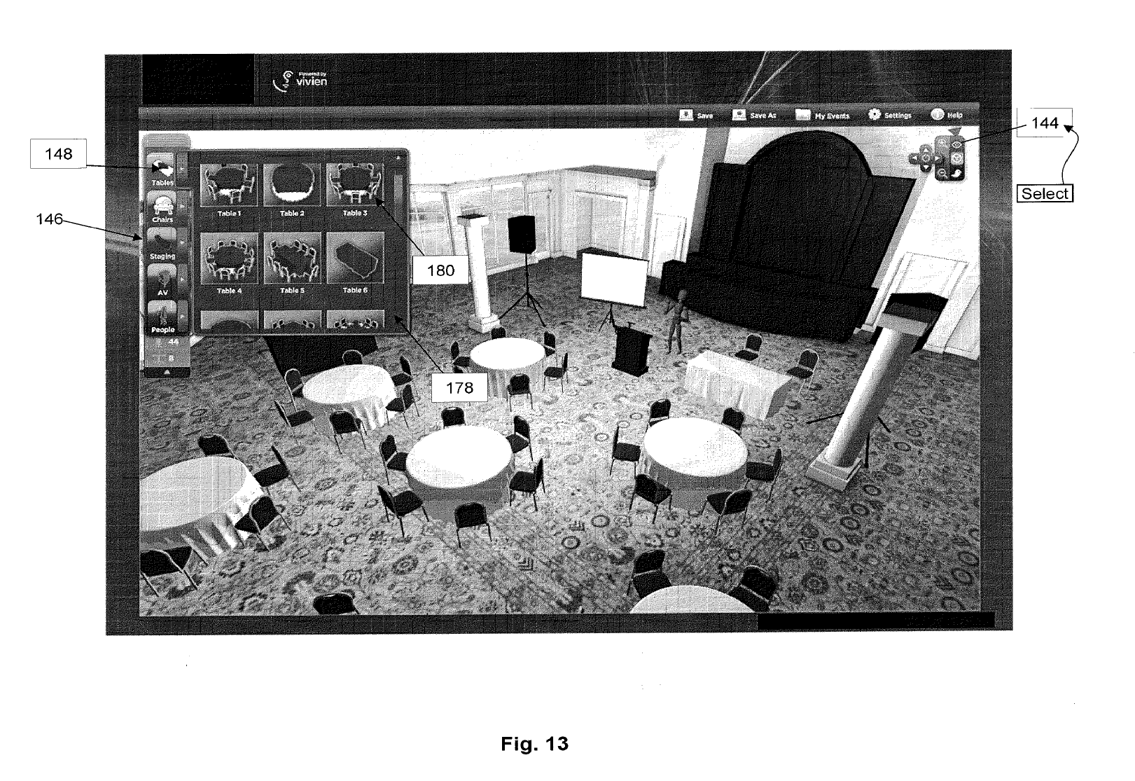

Referring to FIG. 13, selecting the tables button 148 on the control panel 146 causes a display 178 of tables available in the library 42. Navigation controls are provided to search through the available tables. For example, a user can select an image of a table 180 from the display 178 and place a 3D model of the same table in the 3D venue model 138.

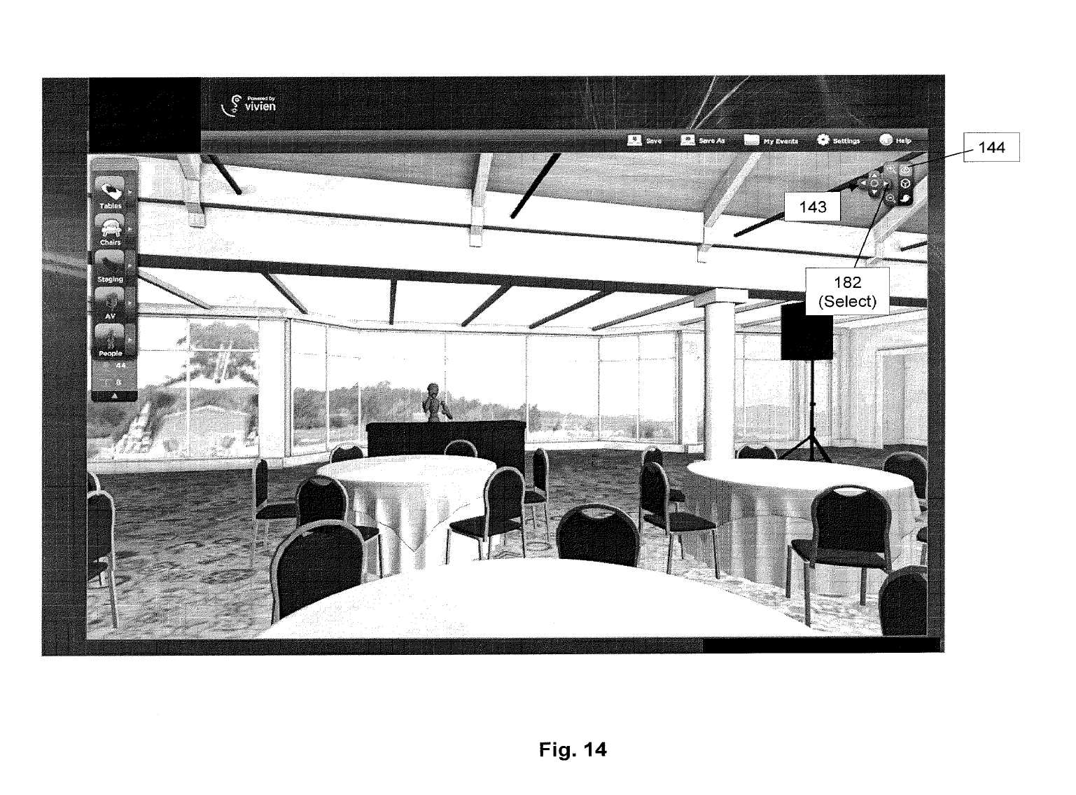

Referring to FIG. 13, selecting the perspective control 144 shows the venue 138 from a first-person view, as shown in FIG. 14.

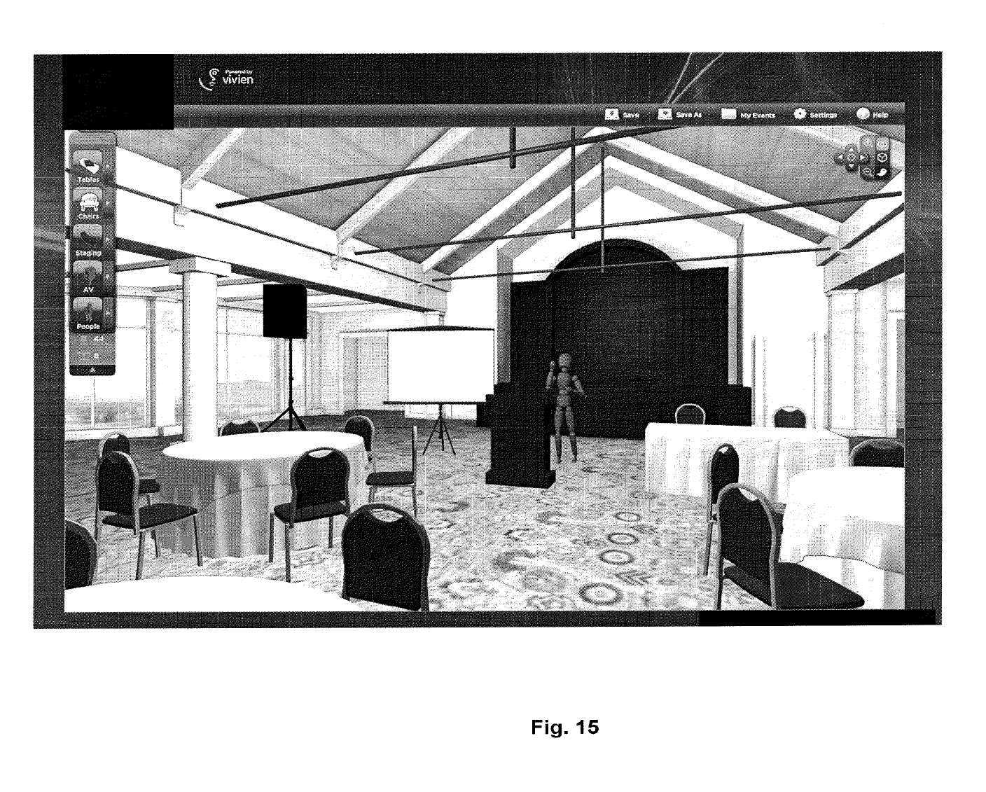

Referring to FIG. 14, a first-person view of the bar 162 is shown. The first-person perspective is indicated, for example, by the control 144 being highlighted. A user can use the navigation arrows 143 to move through the room. For example, selecting the upper arrow while in the first-person perspective causes the point of view to move forward through the room. Selecting the downwards arrow causes the point of view to move backwards through the room. Selecting the left and right arrows causes the point of view to turn left or turn right. For example, selecting the right arrow 182 causes the point of view to turn right. The resulting view is shown in FIG. 15.

Referring to FIG. 15, the point of view is in the same position as in FIG. 14, but the orientation has changed. The first-person view of the venue 138 now shows the person 168 behind the podium 170.

It can be appreciated that the navigation arrows provide different movement effects while in different perspectives. For example, in the isometric perspective, the upwards arrow provides an upwards rotation of the point of view over the room in a spherical manner. The downwards arrow provides a downward rotation of the point of view. In another example, while in the top-down view, the navigation arrows provide up, down, left and right translations.

It can also be appreciated that there may be keyboard shortcuts to navigate the point of view through the 3D venue model. For example, the up, down, left and right arrows on a keyboard of a computing device 6 may be used to navigate through the 3D venue model instead of the arrows provided in the GUI.

Other example keyboard shortcuts include the delete key, which can be used to delete an object from the 3D venue model. This, for example, is an alternative to selecting the “trash can” symbol in the option panel 174 to delete a selected object. Another keyboard shortcut can be used to activate a full screen mode, which only shows the venue in a display screen of the computing device 6. Another keyboard shortcut can be used to export or import data. Another keyboard shortcut is used to switch views between different venues automatically. It can be appreciated that various keyboard shortcuts can be used to control various function of the web application 10.

An example user scenario is provided below which uses the systems and methods described herein.

Karen is a young, working professional who has just recently been engaged. As a bride-to-be, Karen is excited about her wedding day, but she wants to pick out the perfect venue. While she would not be described as tech savvy, Karen knows enough about the internet and social media platforms to use various web technologies.

The Hotel California is a thriving hotel with multiple event rooms, that are rented out to clients for various purposes. As existing users of the 3D virtual environment software (e.g. Vivien), the Hotel California also has various 3D venue models of their event rooms. These 3D files are used by sales fulfillment staff to create virtual mockups of what a client's event might look like. It is a tool for the entire hotel sales team's day-to-day activities.

Understanding the nature of the information age, the Hotel California has purchased a license of the web application 10 so that potential clients may design events from the comfort of their own home.

Meanwhile, Karen has been spending her evenings searching for an ideal hotel to host her wedding reception. Coming across the Hotel California website on her computing device 6, Karen is intrigued by the website's offer to design her reception online. Clicking the “Start Now” button, the web application 10 is loaded and displayed on Karen's computing device 6.

Using her computing device 6, Karen is first presented with a 2D floor plan of the hotel's main event floors. Because the Hotel California has two event floors, Karen has the option of moving between the two floors and viewing the 2D floor plans of each. While in this mode of operation, the 2D floor plan will label all of the Hotel California's event rooms. When Karen moves her mouse over a room in the 2D floor plan, the outline of the room will be highlighted.

Karen, having selected a suitably-sized room, then clicks on it. From there, the web application 10 removes the 2D floor plans and loads a 3D model of the selected room. Using various navigation controls, Karen has the ability to spin and move the camera as if she is “walking through” the room.

From here, Karen has the ability to open a library 42 where various items such as tables, chairs, dance-floors, etc. are available to her. These library items are taken from the Hotel California's existing stock of in-house inventory. By clicking on these items, Karen is able to insert them into the 3D world and design her wedding with no more than a few mouse clicks.

Karen is also able to adjust the mood of her event by moving between two predefined lighting states: day and night time.

After having spent a very short time designing her event, Karen wishes to take a snapshot of what she has created. This will require Karen to register with the web application 10 first, giving her full contact information. The registration process will ask Karen for user-specific information such as: name, telephone, e-mail, etc. In the next step, the registration process will ask Karen if she wants to submit her design to the hotel to be followed up by a hotel sales representative. If she is so inclined, a new Information Template form will appear asking Karen questions such as:

What type of function is this? (Wedding, party, meeting, etc.)

When will this event be held?

How many attendees are you expecting?

What is your budget expectation?

Once the registration process is complete Karen will be able to take snapshots of her virtual event. The snapshots, for example, may be in the .jpg, .png, or .tiff file format. Other image file formats may also be used. For example, after the server 2 receives the name and contact information of Karen (the user), the server 2 enables a function on the web application 10 for taking snapshots or screenshots of Karen's customized 3D venue model. In another example, after the server 2 receives Karen's name and contact information, the server 2 sends, for example via email, a text file (e.g. including the data abstraction of the customized 3D venue and Karen's information) to the server 4 or an email address associated with Hotel California's venue management.

Meanwhile, at the Hotel California's sales office, the sales fulfillment manager receives an e-mail notification that a potential client has expressed interest in a room through the web application 10. The e-mail contains user information from the registration and Information Template forms. The e-mail also contains an XML file which meta references to Karen's virtual event.

The sales fulfillment manager then proceeds to open his copy of the 3D virtual environment software. Using the virtual environment importer 12, the sales fulfillment manager opens Karen's unique XML file and sees the event as she designed it, while she was online. From here, the sales fulfillment manager can follow up with Karen via telephone or e-mail, or even a personal visit.

Various examples and example aspects of the systems and methods are described below.

A method performed by a server is provided for generating a customized 3D venue model. The method includes: providing data of a 3D venue model to a computing device to enable the display of the 3D venue model; providing the computing device access to one or more virtual objects available in an objects library; receiving customization data from the computing device comprising a position of a selected virtual object in the 3D venue model, the selected virtual object from the objects library; saving the customized 3D venue model; and generating a text file comprising a name of the 3D venue model and data describing one or more characteristics of the selected virtual object.

In another aspect, the text file is an XML file. In another aspect, the text file is an abstraction of the 3D venue model that is able to be used to generate the customized 3D venue model in a 3D virtual environment software. In another aspect, the data describing the one or more characteristics of the selected virtual object includes a name of the selected virtual object, the position of the selected virtual object, an orientation of the selected virtual object, a height of the selected virtual object, and a color of the selected virtual object. In another aspect, the server receives a name and contact information of a user associated with the customized 3D venue model, and the text file further includes the name and the contact information of the user. In another aspect, the server sends the text file to another computing device after receiving from the computing device a name and contact information of a user associated with the customized 3D venue model, and the text file further includes the name and the contact information of the user. In another aspect, the server determines if one or more rules apply to the customization data. In another aspect, if the position of the selected virtual object is positioned in a clearance area in the 3D venue model, the server sends a notification to the computing device to move the selected virtual object. In another aspect, the clearance area is defined by a predetermined distance around an emergency exit in the 3D venue model. In another aspect, the clearance area is defined by a predetermined distance from a wall in the 3D venue model. In another aspect, if the position of the selected virtual object is positioned less than a predetermined minimum distance from another virtual object in the 3D venue model, the server provides a new position of the selected virtual object that is at least at the predetermined minimum distance away from the other virtual object. In another aspect, the customization data includes a plurality of virtual chairs placed in the 3D venue model and the method further includes the server determining if the number of the plurality of chairs is greater than a maximum number of people associated with the 3D venue model, and if so, providing a notification to the computing device. In another aspect, the server computes a difference, denoted by x, between the number of the plurality of chairs and the maximum number of people, and the notification includes a message that x chairs need to be removed. In another aspect, after the server receives a name and contact information of a user, the server enables the computing device to save an image of the customized 3D venue model. In another aspect, the image is a .jpg file format, a .png file format, or a .tiff file format. In another aspect, the objects library includes at least one of a virtual chair, a virtual table, and a virtual stage.

A server is provided that includes a process device and a memory device. The server is configured to execute instructions for generating a customized 3D venue model. The instructions include: providing data of a 3D venue model to a computing device to enable the display of the 3D venue model; providing the computing device access to one or more virtual objects available in an objects library; receiving customization data from the computing device comprising a position of a selected virtual object in the 3D venue model, the selected virtual object from the objects library; saving the customized 3D venue model; and generating a text file comprising a name of the 3D venue model and data describing one or more characteristics of the selected virtual object.

A method is provided for generating a customized 3D venue model. The method includes: displaying on a web browser a 3D venue model; displaying one or more virtual objects available in an objects library; customizing the 3D venue model by receiving an input to place a selected virtual object in the 3D venue model; receiving an input to save the customized 3D venue model; and obtaining a text file comprising a name of the 3D venue model and data describing one or more characteristics of the selected virtual object.

Although the above has been described with reference to certain specific example embodiments, various modifications thereof will be apparent to those skilled in the art as outlined in the appended claims.

1. A method performed by a server for generating a customized 3D venue model, the method comprising:
providing data of a 3D venue model to a computing device to enable the display of the 3D venue model;
providing the computing device access to one or more virtual objects available in an objects library;
receiving customization data from the computing device comprising a position of a selected virtual object in the 3D venue model, the selected virtual object from the objects library;
saving the customized 3D venue model; and
generating a text file comprising a name of the 3D venue model and data describing one or more characteristics of the selected virtual object.

2. The method of claim 1 wherein the text file is an XML file.

3. The method of claim 1 wherein the text file is an abstraction of the 3D venue model that is able to be used to generate the customized 3D venue model in a 3D virtual environment software.

4. The method of claim 1 wherein the data describing the one or more characteristics of the selected virtual object comprises at least one of: a name of the selected virtual object, the position of the selected virtual object, an orientation of the selected virtual object, a height of the selected virtual object, and a color of the selected virtual object.

5. The method of claim 1 further comprising the server receiving a name and contact information of a user associated with the customized 3D venue model, and wherein the text file further comprises the name and the contact information of the user.

6. The method of claim 1 further comprising the server sending the text file to another computing device after receiving from the computing device a name and contact information of a user associated with the customized 3D venue model, and wherein the text file further comprises the name and the contact information of the user.

7. The method of claim 1 further comprising the server determining if one or more rules apply to the customization data.

8. The method of claim 1 wherein if the position of the selected virtual object is positioned in a clearance area in the 3D venue model, the server sends a notification to the computing device to move the selected virtual object.

9. The method of claim 8 wherein the clearance area is defined by a predetermined distance around an emergency exit in the 3D venue model.

10. The method of claim 8 wherein the clearance area is defined by a predetermined distance from a wall in the 3D venue model.

11. The method of claim 1 wherein if the position of the selected virtual object is positioned less than a predetermined minimum distance from another virtual object in the 3D venue model, the server provides a new position of the selected virtual object that is at least at the predetermined minimum distance away from the other virtual object.

12. The method of claim 1 wherein the customization data includes a plurality of virtual chairs placed in the 3D venue model and the method further comprises the server determining if the number of the plurality of chairs is greater than a maximum number of people associated with the 3D venue model, and if so, providing a notification to the computing device.

13. The method of claim 12 further comprising the server computing a difference, denoted by x, between the number of the plurality of chairs and the maximum number of people, and wherein the notification includes a message that x chairs need to be removed.

14. The method of claim 1 further comprising, after the server receives a name and contact information of a user, the server enables the computing device to save an image of the customized 3D venue model.

15. The method of claim 14 wherein the image is a .jpg file format, a .png file format, or a .tiff file format.

16. The method of claim 1 wherein the objects library includes at least one of a virtual chair, a virtual table, and a virtual stage.

17. A server comprising a process device and a memory device, the server configured to execute instructions for generating a customized 3D venue model, the instructions comprising:
providing data of a 3D venue model to a computing device to enable the display of the 3D venue model;
providing the computing device access to one or more virtual objects available in an objects library;
receiving customization data from the computing device comprising a position of a selected virtual object in the 3D venue model, the selected virtual object from the objects library;
saving the customized 3D venue model; and
generating a text file comprising a name of the 3D venue model and data describing one or more characteristics of the selected virtual object.

18. A method performed by a computing device for generating a customized 3D venue model, the method comprising:
displaying on a web browser a 3D venue model;
displaying one or more virtual objects available in an objects library;
customizing the 3D venue model by receiving an input to place a selected virtual object in the 3D venue model;
receiving an input to save the customized 3D venue model; and
obtaining a text file comprising a name of the 3D venue model and data describing one or more characteristics of the selected virtual object.
